(19) United States
(12) Patent Application Publication
(10) Pub. No.: US 2025/0200371 A1
(43) Pub. Date: Jun. 19, 2025

(54) ARITHMETIC DEVICE AND ARITHMETIC METHOD

(71) Applicant: Hitachi Astemo, Ltd., Hitachinaka-shi, Ibaraki (JP)

(72) Inventors: Sakie KOMATSU, Hitachinaka-shi, Ibaraki (JP); Hiroaki ITO, Hitachinaka-shi, Ibaraki (JP); Tadashi KISHIMOTO, Hitachinaka-shi, Ibaraki (JP)

(73) Assignee: Hitachi Astemo, Ltd., Hitachinaka-shi, Ibaraki (JP)

(21) Appl. No.: 18/843,990

(22) PCT Filed: Jun. 24, 2022
(86) PCT No.: PCT/JP2022/025251

§ 371 Date: Sep. 4, 2024

(51) Int. Cl. G06N 3/082

(52) U.S. Cl. CPC G06N 3/082

(57) ABSTRACT

An arithmetic device including an importance calculation unit that calculates an importance of a channel by using a weighting factor set for a channel of a multilayer neural network model having a channel including a plurality of neurons for each of an input layer, an intermediate layer, and an output layer; a target contraction rate setting unit that sets a target contraction rate for the entire multilayer neural network model; each layer contraction rate calculation unit that calculates a contraction rate of each layer of the multilayer neural network model based on the importance and the target contraction rate; a contraction unit that contracts each layer in accordance with the contraction rate calculated by each layer contraction rate calculation unit to generate a post-contraction multilayer neural network model; and a relearning unit that performs relearning of the post-contraction multilayer neural network model.

### TECHNICAL FIELD

The present invention relates to an arithmetic device and an arithmetic method.

### BACKGROUND ART

In recent years, techniques for applying object recognition and behavior prediction using machine learning to autonomous driving of a vehicle have been developed. In addition, a DNN model using Deep Neural Network (hereinafter abbreviated as “DNN”) is known as a machine learning method applied to object recognition or the like. Since the DNN model includes many layers, the DNN model is used as an example of a multilayer neural network.

In an autonomous driving system, an object at a periphery of a vehicle is recognized using a DNN model (referred to as “peripheral recognition”), and automatic steering and automatic speed control are performed to control the vehicle to a destination. Therefore, the DNN model is used for a learning process of acquiring a feature of an object from an image and an inference process of extracting an object from the image based on the learning result by the learning process.

In general, when an autonomous driving system using a DNN model controls autonomous driving of a vehicle, first, an image of the outside world is acquired from a camera, and the image is converted into a format usable in the DNN model. In the inference process, an image whose format has been converted is used as an input image, and an object is extracted from the input image using a DNN model that has been subjected to the learning process in advance. Thereafter, the autonomous driving system creates a peripheral map representing the outside world of the vehicle from the extraction result of the object, makes an action plan of the vehicle based on the peripheral map, and controls the vehicle based on the action plan.

As the peripheral map, for example, a map is assumed in which a type of an object such as an object appearing in the image is a vehicle or a person can be recognized based on an image in which the front of the vehicle is. However, not only the front of the vehicle but also an image in which the rear of the vehicle is photographed and an image in which the side of the vehicle is photographed may be used to create the peripheral map. In addition, in creating the peripheral map, an image obtained by photographing the periphery with a camera and information acquired from sensors such as light detection and ranging (LiDAR), and Radar may be used in combination.

PTLs 1 and 2 describe various models using a neural network.

PTL 1 describes “A neural network including a third combination information group created when a decimation unit deletes at least one combination information from a first combination information group based on the first combination information group for determining an output value when an input value is given and a second combination information group that is a plurality of pieces of combination information in which an influence degree on predetermined data given as the input value exceeds a predetermined value”.

PTL 2 describes “efficiently performing model compression by performing learning by a cost function in which an influence degree at time of deletion for each channel/filter is taken into consideration to obtain a scaling coefficient, and determining a deleting target in consideration of the influence degree at time of deletion of the channel/filter based on at least the scaling coefficient”.

### CITATION LIST

### Patent Literature

PTL 1: JP 2020-42496 A
PTL 2: JP 2021-108039 A

### SUMMARY OF INVENTION

### Technical Problem

In a DNN model used in an autonomous driving system, a convolution arithmetic operation including multiplication and addition is repeatedly executed, and thus the number of arithmetic operations is very large. In particular, in autonomous driving, since the autonomous driving system needs to continue to update the action plan within a very short time, high-speed arithmetic operation is required for object recognition by the DNN model. Therefore, when a DNN model is mounted on an in-vehicle autonomous driving ECU (Electronic Control Unit: electronic control device), the number of arithmetic operations needs to be reduced. Therefore, the number of arithmetic operations can be reduced by simplifying the DNN model using contraction. There are various methods for a method of contracting the DNN model, but in the present specification, a description will be given on the assumption that a weighting factor or a process of decimating neurons (pruning), which is one type of contraction, is used.

Conventionally, when contracting a DNN model, a uniform contraction rate is determined for all layers to contract the DNN model. However, when the contraction of all the layers of the DNN model is performed, the contraction is also performed on the layer contributing to the improvement of the recognition accuracy of the object, and the recognition accuracy is greatly reduced.

For this reason, a method for determining the contraction rate of each layer of the DNN model has been studied. In this method, first, neurons in all layers are uniformly deleted in a range in which accuracy degradation is expected to less likely to occur, and then learning is performed on a DNN model in which only neurons of a certain layer are largely deleted to obtain degradation of recognition accuracy. Then, layers in which neurons are to be largely deleted are sequentially changed, degradation of recognition accuracy is compared, and then only layers in which degradation of recognition accuracy can be suppressed are deleted. However, since learning is required many times in this process, the man-hours required to obtain the post-contraction DNN model is considerably increased.

When the DNN model is contracted using the technique described in PTL 1, degradation of recognition accuracy is increased. In addition, in the technique described in PTL 2, relearning is repeated using a DNN model contracted based on the contraction rates set in various patterns, and thus the man-hours for contracting the DNN model is very large.

The present invention has been made in view of such a situation, and an object thereof is to reduce the man-hours for contraction of a multilayer neural network.

### Solution to Problem

An arithmetic device including an importance calculation unit that calculates an importance of a channel by using a weighting factor set for a channel of a multilayer neural network model having a channel including a plurality of neurons for each of an input layer, an intermediate layer, and an output layer; a target contraction rate setting unit that sets a target contraction rate for the entire multilayer neural network each model; layer contraction rate calculation unit that calculates a contraction rate of each layer of the multilayer neural network model based on the importance and the target contraction rate; a contraction unit that contracts each layer in accordance with the contraction rate calculated by each layer contraction rate calculation unit to generate a post-contraction multilayer neural network model; and a relearning unit that performs relearning of the post-contraction multilayer neural network model.

### Advantageous Effects of Invention

According to the present invention, the man-hours for contraction of the multilayer neural network can be reduced.

### BRIEF DESCRIPTION OF DRAWINGS

FIG. 1 is a block diagram illustrating an overall configuration example of an autonomous driving system according to a first embodiment of the present invention.

FIG. 2 is a block diagram illustrating a hardware configuration example of a calculator according to the first embodiment of the present invention.

FIG. 3 is a flowchart illustrating an example of a process of a DNN contraction device according to the first embodiment of the present invention.

FIG. 4 is a diagram illustrating, in a simplified manner, a learned DNN model according to the first embodiment of the present invention.

FIG. 5 is a diagram illustrating a basic form of the convolutional neural network according to the first embodiment of the present invention.

FIG. 6 is a diagram illustrating an example of a post-contraction DNN model according to the first embodiment of the present invention.

FIG. 7 is a block diagram illustrating a configuration example of an autonomous driving system including a DNN contraction device according to a second embodiment of the present invention.

FIG. 8 is a flowchart illustrating an example of a process of a DNN contraction device according to the second embodiment of the present invention.

FIG. 9 is a block diagram illustrating a configuration example of an autonomous driving system including a DNN contraction device according to a third embodiment of the present invention.

FIG. 10 is a flowchart illustrating an example of a process of a DNN contraction device according to the third embodiment of the present invention.

FIG. 11 is a block diagram illustrating a configuration example of an autonomous driving system including a DNN contraction device according to a fourth embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description will be omitted. In the following embodiment, an example will be described in which the present invention is applied to an arithmetic device in which an in-vehicle ECU for vehicle control, for example, advanced driver assistance system (ADAS) or autonomous driving (AD) is communicable.

### First Embodiment

### <Overall Configuration of Autonomous Driving System>

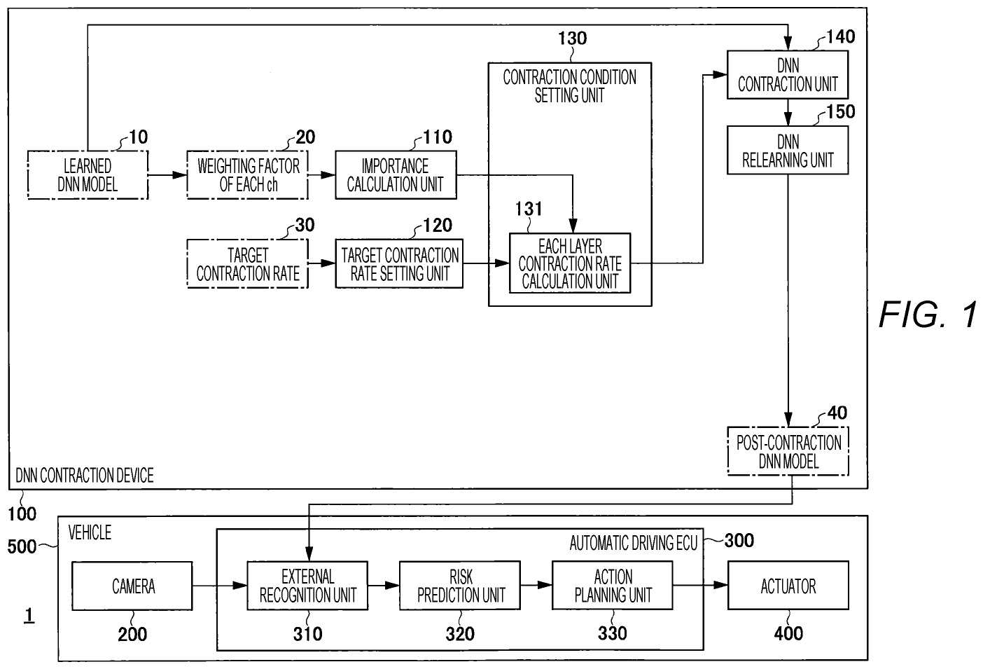

First, a configuration example of an autonomous driving system 1 using a DNN contraction device 100 according to a first embodiment of the present invention will be described with reference to FIG. 1.

FIG. 1 is a block diagram illustrating an overall configuration example of an autonomous driving system according to a first embodiment.

The autonomous driving system 1 includes a DNN contraction device 100 and an autonomous driving ECU 300 mounted on a vehicle 500, controls peripheral recognition and automatic steering of the vehicle 500, and controls autonomous driving of the vehicle 500 to a destination by automatic speed control. A camera 200 and an actuator 400 are also mounted on the vehicle 500. In the autonomous driving ECU 300, the DNN contraction device 100 controls the autonomous driving of the vehicle 500 by using the post-contraction DNN model 40 contracted from the learned DNN model 10.

The camera 200 is an example of a monocular camera or a stereo camera capable of photographing the outside world of the vehicle 500 by visible light and infrared rays. The camera 200 outputs an image obtained by photographing the outside world to the autonomous driving ECU 300 as the outside world information.

The actuator 400 is a device that is driven by the control of the autonomous driving ECU 300, and performs operation of each part such as an accelerator, a brake, and a steering.

First, an internal configuration example and an operation example of the autonomous driving ECU 300 will be described.

The autonomous driving ECU 300 includes an external recognition unit 310, a risk prediction unit 320, and an action planning unit 330. Each functional unit of the autonomous driving ECU 300 illustrated in FIG. 1 is a main part necessary for the autonomous driving of the vehicle 500, and description and illustration of other functional units necessary for the autonomous driving are omitted.

The external recognition unit 310 recognizes an object in the outside world based on the outside world information acquired from the camera 200. The object recognized by the external recognition unit 310 is output to the risk prediction unit 320 as an object recognition result. The external recognition unit 310 uses the post-contraction DNN model 40 output from the DNN relearning unit 150 to be described later in the outside world recognition process.

The risk prediction unit 320 predicts a risk considered from the current outside world situation by using the object recognition result input from the external recognition unit 310. The risk predicted by the risk prediction unit 320 is output to the action planning unit 330 as a risk prediction result.

The action planning unit 330 generates an action plan including the advancing direction, the advancing speed, and the like of the vehicle 500 based on the risk prediction result input from the risk prediction unit 320. The action plan generated by the action planning unit 330 is output to the actuator 400. The actuator 400 drives each part of the vehicle 500 according to the action plan, thereby realizing autonomous driving of the vehicle 500.

Next, an internal configuration example of the DNN contraction device 100 will be described.

Assume that the DNN contraction device 100 is provided in a cloud server installed at a place away from the vehicle 500. The autonomous driving ECU 300 downloads the post-contraction DNN model 40 from the DNN contraction device 100 every time the autonomous driving ECU 300 is activated. By providing the DNN contraction device 100 in the cloud server, it becomes possible to cause the cloud server to bear a load such as the contraction process of the learned DNN model 10.

The DNN contraction device 100 is a device that performs contraction process of the learned DNN model 10. A large amount of arithmetic process is required for the contraction process of the learned DNN model 10. The DNN contraction device 100 includes an importance calculation unit 110, a target contraction rate setting unit 120, a contraction condition setting unit 130, a DNN contraction unit 140, and a DNN relearning unit 150. In the following drawings, a rectangle surrounded by a solid line represents a subject of various types of processes, and a rectangle surrounded by a one-dot chain line represents various types of data or information.

The importance calculation unit 110 and the target contraction rate setting unit 120 are connected to each layer contraction rate calculation unit 131.

The importance calculation unit (importance calculation unit 110) calculates the importance of the channel by using the weighting factor 20 of each ch set to the channel of the multilayer neural network model (learned DNN model 10) having the channel including a plurality of neurons for each of the input layer, the intermediate layer, and the output layer. This multilayer neural network model is a deep neural network model and is used as the learned DNN model 10. Therefore, the importance calculation unit 110 extracts the weighting factor 20 of each channel (hereinafter abbreviated as “ch”) from the learned DNN model 10. Then, the importance calculation unit 110 calculates the importance of each ch using the weighting factor 20 of each ch. The importance is an index representing the influence on the recognition accuracy by each ch of the learned DNN model 10. The importance of each ch calculated by the importance calculation unit 110 is output to each layer contraction rate calculation unit 131.

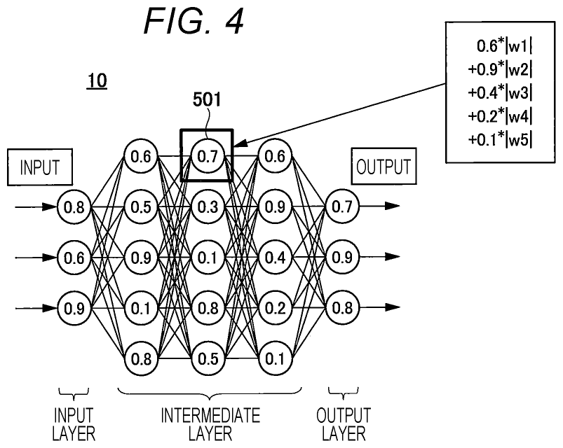

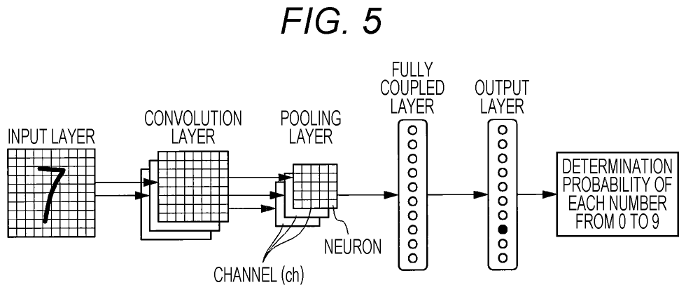

Here, ch in the learned DNN model 10 will be described with reference to FIGS. 4 and 5.

FIG. 4 is a schematic diagram of the learned DNN model 10.

The learned DNN model 10 is an example of a multilayer neural network, and includes an input layer, a plurality of intermediate layers, and an output layer. Each layer of the learned DNN model 10 is configured by a neural network including a plurality of neurons. A plurality of neurons of the front layer and a plurality of neurons of the rear layer are connected to neurons of a certain layer of the intermediate layer.

FIG. 5 is a diagram illustrating a basic form of the convolutional neural network.

The input image data (with the numeral “7”) is divided into a predetermined size and taken into the input layer. The value of a neuron in a certain layer is convoluted by a filter into a plurality of convolution layers for each filter by convoluting values of a plurality of neurons of a previous layer by a filter. Then, pooling process is performed on each convolution layer to generate a pooling layer. Here, one cell of the pooling layer is referred to as a neuron, and a set of each of the neurons in the pooling layer is referred to as a channel (ch). The output of the pooling layer is collected into a fully coupled layer. Then, the determination probabilities from “0” to “9” are output in the output layer connected to the fully coupled layer. The eighth black circle from the top of the output layer indicates that the probability that the determined number is “7” is the highest. Note that, in the learned DNN model 10 illustrated in FIG. 4, a plurality of sets of convolution layers and pooling layers are present in each layer of the intermediate layer.

Returning to FIG. 1, the description will be continued. A target contraction rate setting unit (target contraction rate setting unit 120) sets a target contraction rate of the entire multilayer neural network model (learned DNN model 10). For example, the target contraction rate setting unit 120 sets the percentage of ch to be reduced in the entire learned DNN model 10 and not for each layer of the learned DNN model 10. Therefore, the target contraction rate setting unit 120 sets the target contraction rate based on the target contraction rate 30 input in advance by the user. The target contraction rate set by the target contraction rate setting unit 120 is output to each layer contraction rate calculation unit 131.

The contraction condition setting unit 130 sets a condition for contracting the DNN from conditions such as the weighting factor 20 and the number of arithmetic operations. The contraction condition setting unit 130 includes each layer contraction rate calculation unit 131.

Each layer contraction rate calculation unit (each layer contraction rate calculation unit 131) calculates a contraction rate of each layer of the multilayer neural network model (learned DNN model 10) based on the importance and the target contraction rate. Each layer contraction rate calculation unit 131 is connected to the DNN contraction unit 140. Each layer contraction rate calculation unit 131 calculates the contraction rate of each layer so that the learned DNN model 10 has the target contraction rate based on the importance calculated by the importance calculation unit 110 and the contraction rate of the entire learned DNN model 10 set by the target contraction rate setting unit 120. For example, each layer contraction rate calculation unit 131 calculates the contraction rate of each layer using the importance of each ch and the set target contraction rate as inputs. The contraction rate of each layer calculated by each layer contraction rate calculation unit 131 is output to the DNN contraction unit 140.

The contraction unit (DNN contraction unit 140) contracts each layer in accordance with the contraction rate calculated by each layer contraction rate calculation unit (each layer contraction rate calculation unit 131) to generate a post-contraction multilayer neural network model (post-contraction DNN model 40). The DNN contraction unit 140 is connected to the DNN relearning unit 150. The learned DNN model 10 and the contraction rate of each layer calculated by each layer contraction rate calculation unit 131 are input to the DNN contraction unit 140. Then, the DNN contraction unit 140 contracts the learned DNN model 10 according to the contraction rate of each layer set by each layer contraction rate calculation unit 131. For example, in a case where 10% is set as the contraction rate of a certain layer of the learned DNN model 10, contraction of deleting ch of this layer by 10% is performed. The learned DNN model 10 contracted by the DNN contraction unit 140 is output to the DNN relearning unit 150 as the post-contraction DNN model 40.

The relearning unit (DNN relearning unit 150) performs relearning of the post-contraction multilayer neural network model (post-contraction DNN model 40). The DNN relearning unit 150 is connected to the external recognition unit 310 of the autonomous driving ECU 300. The post-contraction DNN model 40 is input from the DNN contraction unit 140 to the DNN relearning unit 150. Here, the post-contraction DNN model 40 input to the DNN relearning unit 150 is not illustrated. Then, the DNN relearning unit 150 performs relearning of the input post-contraction DNN model 40. For example, the DNN relearning unit 150 reads learning data (not illustrated), performs relearning of the post-contraction DNN model 40, reads evaluation data (not illustrated), and evaluates the post-contraction DNN model 40. Then, if it can be confirmed that the recognition accuracy of the object of the post-contraction DNN model 40 is higher than or equal to the target recognition accuracy, the DNN relearning unit 150 outputs the post-contraction DNN model 40 to the external recognition unit 310 of the autonomous driving ECU 300. As described above, the process in which the DNN relearning unit 150 performs relearning of the post-contraction DNN model 40 merely needs to be performed at least once.

Note that the DNN contraction device 100 may be in a mode of being mounted on the vehicle 500. In this case, even in an environment where the vehicle 500 cannot be connected to a wireless network (tunnels, underground passages, etc.), the post-contraction DNN model 40 generated by the DNN contraction device 100 and relearned is immediately input to the external recognition unit 310. Therefore, even in an environment where the vehicle 500 cannot be connected to a wireless network, the external recognition unit 310 can accurately recognize an object.

### <Hardware Configuration of Calculator>

Next, a hardware configuration of a calculator 600 constituting the DNN contraction device 100 will be described.

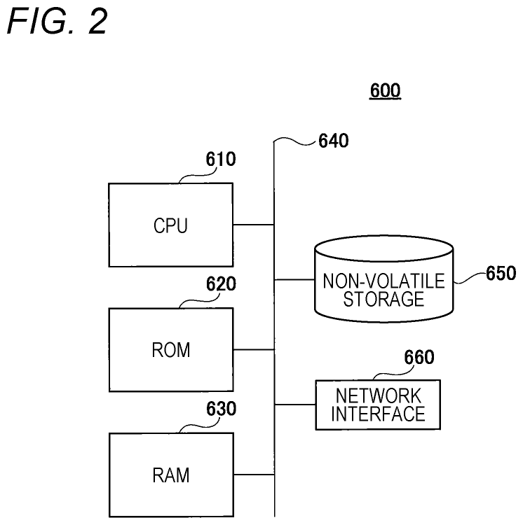

FIG. 2 is a block diagram illustrating a hardware configuration example of the calculator 600. The calculator 600 is an example of hardware used as a computer operable as the DNN contraction device 100 according to the present embodiment. The DNN contraction device 100 according to the present embodiment implements a DNN contraction arithmetic method performed by the respective functional blocks illustrated in FIG. 1 in cooperation with each other by the calculator 600 (computer) executing a program.

The calculator 600 includes a central processing unit (CPU) 610, a read only memory (ROM) 620, and a random access memory (RAM) 630 each connected to a bus 640. Furthermore, the calculator 600 further includes a nonvolatile storage 650 and a network interface 660.

The CPU 610 reads a program code of software for realizing each function according to the present embodiment from the ROM 620, loads the program code into the RAM 630, and executes the program code. Variables, parameters, and the like generated during arithmetic process of the CPU 610 are temporarily written to the RAM 630, and these variables, parameters, and the like are appropriately read by the CPU 610. However, a micro processing unit (MPU) may be used instead of the CPU 610. The CPU 610 realizes process of each functional unit included in the DNN contraction device 100.

As the nonvolatile storage 650, for example, a hard disk drive (HDD), a solid state drive (SSD), a flexible disk, an optical disk, a magneto-optical disk, a CD-ROM, a CD-R, a magnetic tape, a nonvolatile memory, or the like is used. In addition to an operating system (OS) and various parameters, a program for causing the calculator 600 to function is recorded in the nonvolatile storage 650. The ROM 620 and the nonvolatile storage 650 is recorded with programs, data, and the like necessary for the operation of the CPU 610, and are used as an example of a computer-readable non-transitory storage medium storing a program executed by the calculator 600. The learned DNN model 10 and the post-contraction DNN model 40 are saved in the nonvolatile storage 650.

For example, a network interface card (NIC) or the like is used as the network interface 660, and various data can be transmitted and received between devices via a local area network (LAN), a dedicated line, or the like connected to a terminal of the NIC. The DNN contraction device 100 transmits the post-contraction DNN model 40 to the autonomous driving ECU 300 via the network interface 660.

### Operation Example of DNN Contraction Device

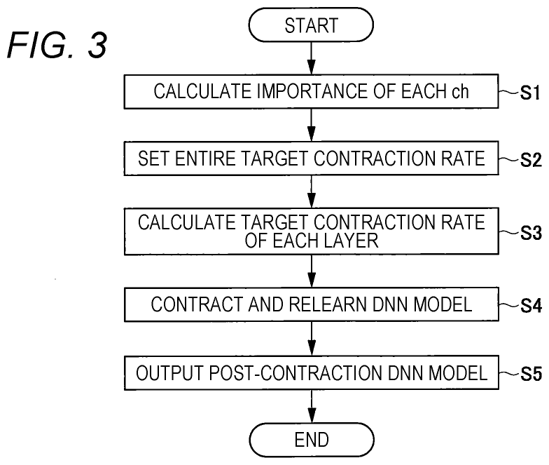

Next, the operation of the DNN contraction device 100 will be described with reference to FIG. 3. FIG. 3 is a flowchart illustrating an example of a process of the DNN contraction device 100 according to the first embodiment.

As described above, the DNN contraction device 100 includes the learned DNN model 10 learned in advance. Then, the DNN contraction device 100 acquires the weighting factor 20 of each ch from the learned DNN model 10.

First, the importance calculation unit 110 calculates the importance of each ch (S1). Here, a calculation procedure of the importance performed by the importance calculation unit 110 will be described with reference to FIG. 4.

FIG. 4 is a diagram illustrating the learned DNN model 10 in a simplified manner.

Each layer of the intermediate layer of the learned DNN model 10 illustrated in FIG. 4 includes 5 chs. Here, in FIG. 4, 1 ch in the intermediate layer in the learned DNN model 10 is illustrated as a region 501. Next, a procedure in which the importance calculation unit 110 calculates the importance of ch indicated in the region 501 will be described.

The importance of each ch represents the degree of influence on the recognition accuracy of each ch. Then, it is known that, among the ch of each layer of the intermediate layer, the average value of the importance of the layer close to the input layer is large, and the average value of the importance of the layer close to the output layer is small. The ch having larger importance is less likely to be deleted in the later process. Conventionally, a layer close to the output layer and having low importance had a small number of arithmetic operations, and thus practically all the layers were deleted.

Therefore, the importance calculation unit 110 calculates the importance such that the importance of a ch having a large variance of the weighting factor 20 or a ch having a feature different from that of other chs becomes high. For example, it can be said that ch having an importance of 0.9 has a large variance. In addition, since the ch different from the feature of the other ch is reflected with the feature amount different from the feature amount of the other ch, there is a possibility that the recognition accuracy is affected if the ch is deleted in the later process. Therefore, the importance calculation unit 110 calculates the importance of ch different from the features of other ch to be high, thereby making it difficult for this ch to be deleted in the later process.

The importance calculation unit (importance calculation unit 110) calculates the importance of the channel at the preceding stage connected to the channel at the subsequent stage in order from the layer closer to the output layer based on the importance of the channel at the subsequent stage and the weighting factor 20 of each channel at the subsequent stage. In the learned DNN model 10 illustrated in FIG. 4, the importance of ch at the subsequent stage of the region 501 (i.e., ch on the right side of the region 501) are 0.6, 0.9, 0.4, 0.2, and 0.1. Therefore, assuming that the weighting factors 20 of each ch are w1, w2, w3, w4, and w5, the importance calculation unit 110 calculates the importance of the region 501 by the following Formula (1).

$$\begin{matrix}[ Mathematical Formula 1 ] & \\ 0.6 * \vert w 1 \vert + 0.9 * \vert w 2 \vert + 0.4 * \vert w 3 \vert + 0.2 * \vert w 4 \vert + 0.1 * \vert w 5 \vert & ( 1 )\end{matrix}$$

Normally, when the weighting factor 20 of each ch is used in the arithmetic operation, the weighting factor 20 takes either positive or negative values, and thus an absolute value is not used. However, in Formula (1), when the value of the weighting factor 20 increases in both positive and negative cases, the influence on the arithmetic operation is large, and the channel becomes a channel that is not to be deleted, and thus an absolute value is used.

Returning again to FIG. 3, the description will be continued.

After step S1, the target contraction rate setting unit 120 sets a target contraction rate 30 set in advance by the user (S2). The target contraction rate 30 is an index indicating how many number of arithmetic operations are reduced to make the learned DNN model 10 to a DNN model (post-contraction DNN model 40), and is a target contraction rate in the entire learned DNN model 10.

Next, each layer contraction rate calculation unit (each layer contraction rate calculation unit 131) calculates a target contraction rate of each layer with respect to a target contraction rate in the entire multilayer neural network model (learned DNN model 10) based on the importance in each layer of the importance calculated for each channel. For example, each layer contraction rate calculation unit 131 calculates a target contraction rate of each layer based on the importance of each ch calculated by the importance calculation unit 110 and the target contraction rate 30 set by the target contraction rate setting unit 120 (S3). The target contraction rate of each layer is an index indicating how much ch to reduce among the chs in each layer of the learned DNN model 10, and can be contracted for each layer as compared with a case where only the entire target contraction rate is used as in the related art.

Next, the DNN contraction unit 140 performs contraction of the learned DNN model 10 based on the input learned DNN model 10 and the target contraction rate of each layer calculated by each layer contraction rate calculation unit 131. The DNN relearning unit 150 uses the contracted learned DNN model 10 as the post-contraction DNN model 40, and relearns the post-contraction DNN model 40 (S4).

Next, the DNN relearning unit 150 outputs the relearned post-contraction DNN model 40 to the autonomous driving ECU 300 of the vehicle 500 (S5). After the process of step S5, the process of the DNN contraction device 100 ends.

Here, a state in which the learned DNN model 10 illustrated in FIG. 4 is contracted will be described.

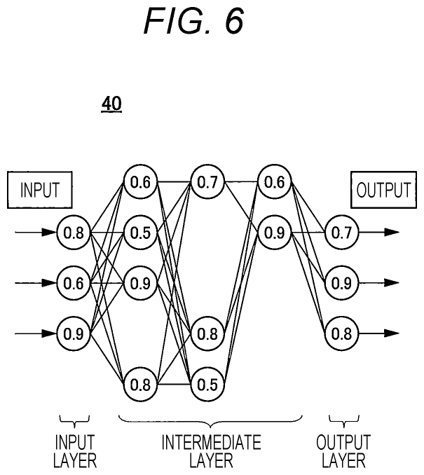

FIG. 6 is a diagram illustrating an example of the post-contraction DNN model 40. Here, contraction process in a case where the target contraction rate 30 in the learned DNN model 10 is set to 40% will be described.

In order to simplify the description, it is assumed that the number of arithmetic operations of each intermediate layer is the same. In this case, the DNN contraction unit 140 reduces chs in ascending order of importance among the plurality of chs included in the intermediate layer. For example, the DNN contraction unit 140 reduces 6 chs for which the target contraction rate 30 is 40% from the 15 chs in the intermediate layer of the learned DNN model 10 illustrated in FIG. 4 in order of low importance. As a result, the post-contraction DNN model 40 illustrated in FIG. 6 in which the number of ch of the intermediate layer is 9 chs is created. The post-contraction DNN model 40 is relearned by the DNN relearning unit 150 and then output to the external recognition unit 310.

In the DNN contraction device 100 according to the first embodiment described above, the ch of the learned DNN model 10 is reduced in ascending order of importance according to the target contraction rate 30 to create the post-contraction DNN model 40. Then, the DNN contraction device 100 obtains an optimum contraction rate in advance by using the importance calculated from the weighting factor 20 of each ch in the importance analysis and the number of arithmetic operations for each layer. Therefore, the DNN contraction device 100 can suppress reduction in the recognition accuracy of the object using the post-contraction DNN model 10 by contracting the learned DNN model 40 using the importance. Furthermore, the DNN contraction device 100 merely needs to perform relearning of the post-contraction DNN model 40 at least once. Therefore, it is not necessary to repeat relearning of the DNN model as in the conventional case, and it is possible to reduce the man-hours for contracting the learned DNN model 10.

In addition, the number of chs of the post-contraction DNN model 40 is reduced as compared with the pre-contraction learned DNN model 10. Therefore, the external recognition unit 310 can reduce the number of arithmetic operations of the external recognition process using the post-contraction DNN model 40 and quickly obtain necessary information such as an external recognition result.

Furthermore, since the learned DNN model 10 is contracted according to the target contraction rate 30 set by the user, the learned DNN model 10 is contracted to the contraction rate intended by the user. That is, the learned DNN model 10 is not excessively contracted, and the recognition accuracy of the post-contraction DNN model 40 is not reduced, or conversely, the number of arithmetic operations by the autonomous driving ECU 300 is not increased as a result of the contraction not being performed.

Note that, in the first embodiment, the external information is acquired from the image imaged by the camera 200, but a sensor capable of acquiring the distance to the object and the type of the object, such as a Lidar, a Radar, or a far infrared camera, may be used, and the means for acquiring the external information is not limited to the camera 200. In addition, a sensor capable of acquiring external information may be used alone, or a plurality of sensors may be used in combination.

Furthermore, the autonomous driving ECU 300 may save an external recognition result by the external recognition unit 310, a risk prediction result by the risk prediction unit 320, and an action plan by the action planning unit 330. Then, the DNN contraction device 100 may acquire these pieces of information from the autonomous driving ECU 300, calculate the DNN model again, and use the calculated DNN model as the learned DNN model 10.

### Second Embodiment

The each layer contraction rate calculation unit 131 of the DNN contraction device 100 according to the first embodiment illustrated in FIG. 1 calculates the contraction rate of each layer based on the importance of each ch. However, only by using the importance of each ch, the weighting factor 20 of the second half layer (layer close to the output layer) of the learned DNN model 10 is easily calculated to be small, and thus the importance of ch of the second half layer is reduced, and ch of the second half layer is likely to become the target of contraction. However, since the number of arithmetic operations is originally small in the second half layer of the learned DNN model 10, it is assumed that the effect of contraction is less likely to be obtained. Therefore, the number of arithmetic operations is also taken into consideration when each layer contraction rate calculation unit 131 calculates the contraction rate of each layer. As a result, it is possible to avoid only a layer having a small number of arithmetic operations from becoming the target of contraction.

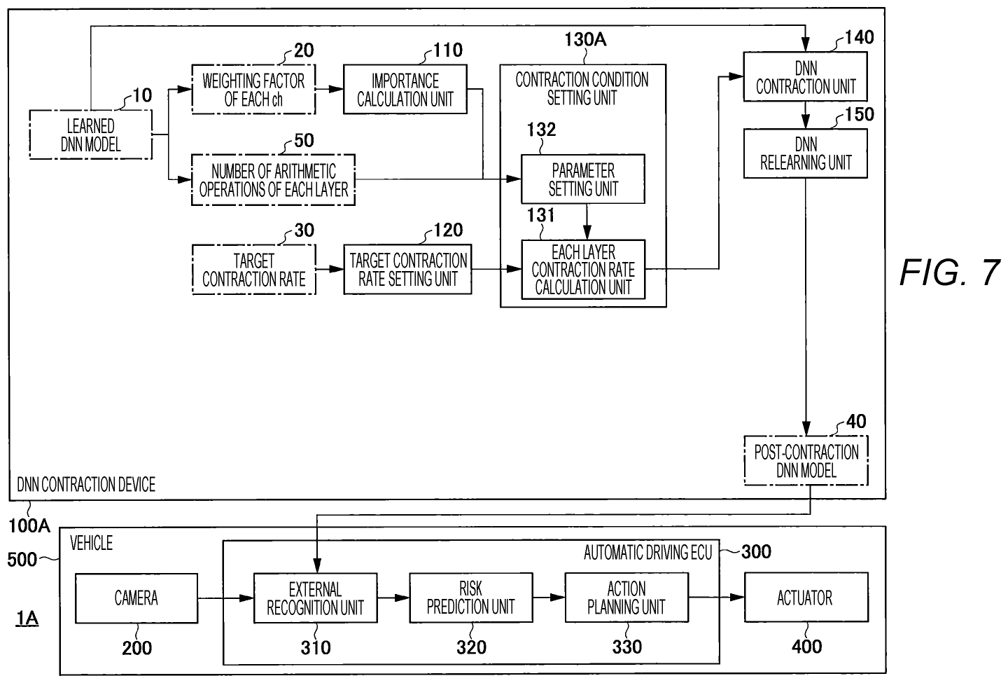

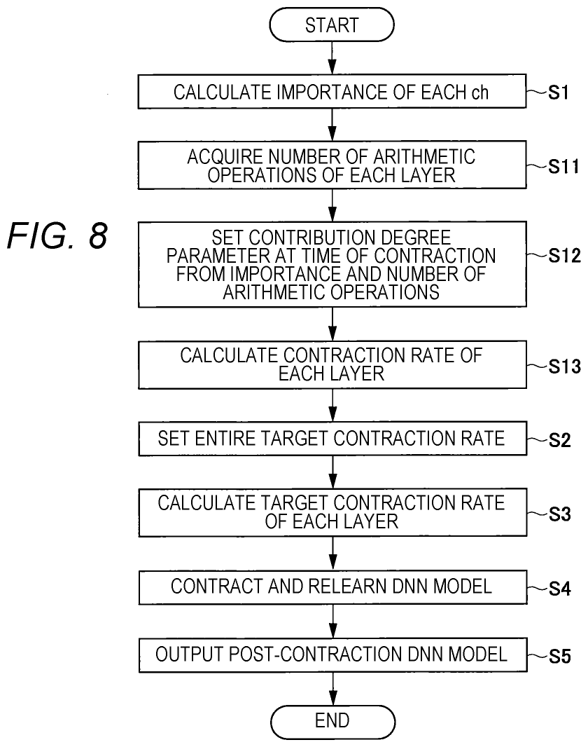

Therefore, a configuration example and an operation example of an autonomous driving system according to a second embodiment of the present invention will be described with reference to FIGS. 7 and 8.

FIG. 7 is a block diagram illustrating a configuration example of an autonomous driving system 1A including a DNN contraction device 100A according to the second embodiment. In FIG. 7, the same names and numbers are given to functional blocks that perform the same process as in FIG. 1, and unless otherwise specified, the functional blocks are assumed to have the same or similar functions, and the description thereof will be omitted.

An autonomous driving system 1A according to the second embodiment illustrated in FIG. 7 includes a DNN contraction device 100A and an autonomous driving ECU 300.

The contraction condition setting unit 130A included in the DNN contraction device 100A newly includes a parameter setting unit 132 in addition to each layer contraction rate calculation unit 131. The parameter setting unit 132 sets a parameter that contributes when the contraction rate of each layer is calculated by each layer contraction rate calculation unit 131. This parameter is also referred to as a contribution degree parameter.

The parameter setting unit (parameter setting unit 132) sets the importance and the number of arithmetic operations of each layer extracted from the multilayer neural network model (learned DNN model 10) as parameters. In addition to the importance for each ch calculated by the importance calculation unit 110, the number of arithmetic operations 50 of each layer extracted from the learned DNN model 10 is input to the parameter setting unit 132. The number of arithmetic operations 50 of each layer is, for example, the number of connection lines of a plurality of chs of the next layer connected to 1 cn of a certain layer in the example of the learned DNN model 10 illustrated in FIG. 4. In FIG. 4, since it is an example of the simplified learned DNN model 10, 5 chs in the next layer (the middle layer of the intermediate layer) is connected to 1 ch in the layer on the input side of the intermediate layer. Then, the number of arithmetic operations of 1 ch of the layer on the input side of the intermediate layer and ch of the next layer is “5”. Since the number of arithmetic operations on ch of the next layer is obtained for each ch in a certain layer, the total number of arithmetic operations on ch of each layer is obtained as the number of arithmetic operations 50 of each layer.

Then, the parameter setting unit 132 sets parameters that determine the importance and the contribution degree of the number of arithmetic operations depending on whether or not the recognition accuracy and the operation speed of the learned DNN model 10 have achieved each goal. At this time, the parameter setting unit (parameter setting unit 132) sets, as parameters (contribution degree parameters), the contribution degree of the importance calculated for each channel and the contribution degree of the number of arithmetic operations 50 of each layer, which are used when each layer contraction rate calculation unit 131 calculates the contraction rate. By setting the contribution degree of the importance calculated for each channel and the contribution degree of the number of arithmetic operations 50 of each layer as parameters (contribution degree parameters), the learned DNN model 10 is contracted based on the importance and the number of arithmetic operations 50 of each layer. Note that the parameter setting may be rephrased as parameter adjustment. The contribution degree parameter set by the parameter setting unit 132 is input to each layer contraction rate calculation unit 131.

Each layer contraction rate calculation unit (each layer contraction rate calculation unit 131) calculates a target contraction rate of each layer based on the parameter (contribution degree parameter) and the target contraction rate. For example, each layer contraction rate calculation unit 131 calculates the contraction rate of each layer based on the contraction rate, the importance, the number of arithmetic operations, and the contribution degree parameter of the entire learned DNN model 10 determined by the target contraction rate setting unit 120.

FIG. 8 is a flowchart illustrating an example of a process of the DNN contraction device 100 according to the second embodiment. Note that in the process illustrated In FIG. 8, the same processes as in FIG. 3 are given the same reference numbers, and unless otherwise specified, the processes are assumed to have the same or similar functions, and the description thereof will be omitted.

As illustrated in FIG. 3, the DNN contraction device 100 has a learned DNN model 10 learned in advance. Then, the DNN contraction device 100 acquires the weighting factor 20 of each ch from the learned DNN model 10. Then, the importance calculation unit 110 calculates the importance of each ch based on the weighting factor 20 of each ch (S1).

Next, the parameter setting unit 132 of the DNN contraction device 100 acquires the number of arithmetic operations 50 of each layer in addition to the importance of each ch calculated from the weighting factor 20 of each ch according to the first embodiment (S11).

Next, the parameter setting unit 132 sets a contribution degree parameter of each ch when the learned DNN model 10 is contracted based on the contribution degree of the importance of each ch and the number of arithmetic operations of each ch (S12). Then, the parameter setting unit 132 calculates the contraction rate of each layer by applying the set contribution degree parameter to the following Formula (2) for calculating the contraction rate of each layer (S13). For example, the parameter setting unit 132 sets the contribution degree x of the importance to 0.5 and the contribution degree y of the number of arithmetic operations to 0.5.

$$\begin{matrix}[ Mathematical Formula 2 ] & \\ C ( L ) = {\{ \frac{1}{log ( P ( L )} \}}^{x} \times {\{ - log ( \frac{O ( L )}{\sum O ( L )} ) \}}^{y} \times base\_rate & ( 2 )\end{matrix}$$

In the Formula (2), C(L) represents a contraction rate of each layer. P(L) represents the importance of each layer. x represents the contribution degree of the importance. O(L) represents the number of arithmetic operations 50 of each layer. y represents the contribution degree of the number of arithmetic operations. base_rate represents the target contraction rate 30.

In the example described above, the contribution degree x of the importance and the contribution degree y of the number of arithmetic operations are the same 0.5, but different values are assumed in which the contribution degree x of the importance is 0.3 and the contribution degree y of the number of arithmetic operations is 0.6. The initial value of the contribution degree x of the importance and the initial value of the contribution degree y of the number of arithmetic operations can be determined in advance, for example, by the user. The process after the contraction rate of each layer is calculated by each layer contraction rate calculation unit 131 in step S13 is similar to the process in the DNN contraction device 100 according to the first embodiment.

In the autonomous driving system 1A according to the second embodiment described above, the importance and the contribution degree parameter of the number of arithmetic operations are set using the importance for each ch analyzed by the importance calculation unit 110 using the importance analysis and the number of arithmetic operations 50 of each layer extracted from the learned DNN model 10. Then, each layer contraction rate calculation unit 131 calculates a contraction rate of each layer based on the contribution degree parameter. Each layer contraction rate calculation unit 131 can avoid only a layer having a small number of arithmetic operations from becoming the target of contraction by using the contribution degree parameter of the number of arithmetic operations for the calculation of the contraction rate.

In addition, each layer contraction rate calculation unit 131 can avoid a layer having a high importance from becoming the target of contraction by using the contribution degree parameter of the importance for the calculation of the contraction rate. As a result, the DNN contraction unit 140 can contract the learned DNN model 10 according to the target contraction rate 30 by leaving ch having high importance of the learned DNN model 10 and reducing ch having a large number of arithmetic operations. As a result, the autonomous driving ECU 300 can quickly execute the arithmetic process of the external recognition performed using the post-contraction DNN model 40 in which the total number of arithmetic operations is greatly reduced. In addition, the autonomous driving ECU 300 can reliably recognize an object to be recognized and control driving of the vehicle 500 while avoiding the object.

### Third Embodiment

When the learned DNN model 10 is contracted using the method according to the first embodiment described above (see FIG. 3), the recognition accuracy of the post-contraction DNN model 40 may be reduced. Similarly, when the learned DNN model 10 is contracted using the method according to the second embodiment described above (see FIG. 8), the recognition accuracy of the post-contraction DNN model 40 may be reduced. Therefore, the DNN contraction device according to the third embodiment confirms the recognition accuracy of the post-contraction DNN model 40, and adjusts the contraction rate from the confirmation result of the recognition system, thereby maintaining the recognition accuracy that ensures safety.

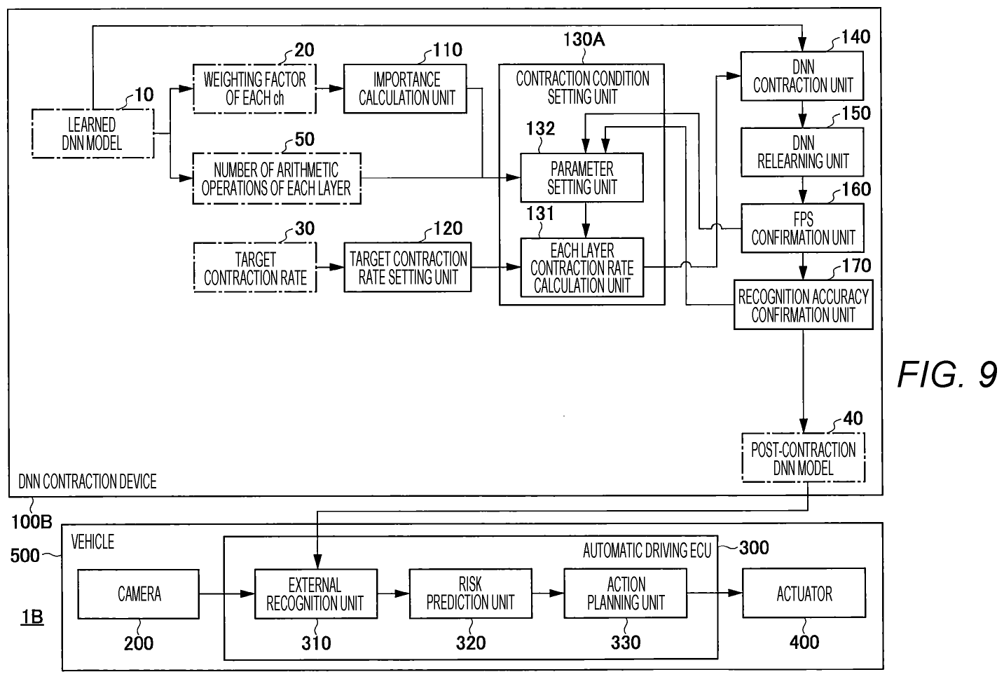

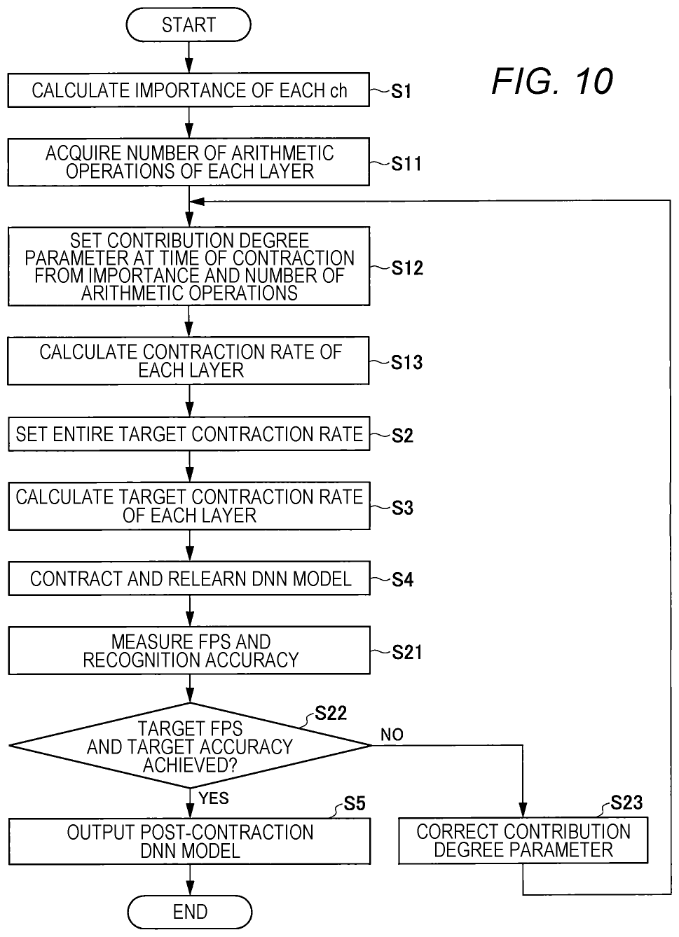

Therefore, a configuration example and an operation example of an autonomous driving system according to a third embodiment of the present invention will be described with reference to FIGS. 9 and 10.

FIG. 9 is a block diagram illustrating a configuration example of an autonomous driving system 1B including a DNN contraction device 100B according to the third embodiment. In FIG. 9, the same names and numbers are given to blocks that perform the same process as in FIG. 7, and unless otherwise specified, the blocks are assumed to have the same or similar functions, and the description thereof will be omitted.

The autonomous driving system 1B according to the third embodiment includes a DNN contraction device 100B and an autonomous driving ECU 300. The DNN contraction device 100B has a configuration in which a frames per second (FPS) confirmation unit 160 and a recognition accuracy confirmation unit 170 are newly added to the DNN contraction device 100A according to the second embodiment. In the following description, fps is also referred to as an operation speed.

The DNN relearning unit 150 is connected to the FPS confirmation unit 160. Therefore, the post-contraction DNN model 40 relearned by the DNN relearning unit 150 is output to the FPS confirmation unit 160.

The operation speed confirmation unit (FPS confirmation unit 160) confirms the operation speed from the relearned post-contraction multilayer neural network model (post-contraction DNN model 40). The FPS confirmation unit 160 is connected to the parameter setting unit 132 and the recognition accuracy confirmation unit 170. The FPS confirmation unit 160 measures the operation speed of the post-contraction DNN model 40 input from the DNN relearning unit 150, and confirms whether or not the operation speed of the post-contraction DNN model 40 satisfies the target operation speed. For example, the recognition accuracy confirmation unit 170 causes the post-contraction DNN model 40 to read several tens of images having a known data amount, and obtains the number of images that can be processed by the post-contraction DNN model 40 within a predetermined time as an operation speed. As the operation speed becomes faster, the number of images that can be processed by the post-contraction DNN model 40 per one second becomes larger. The confirmation result of the operation speed of the post-contraction DNN model 40 by the FPS confirmation unit 160 is output to the parameter setting unit 132. In addition, the FPS confirmation unit 160 outputs the post-contraction DNN model 40 to the recognition accuracy confirmation unit 170.

The recognition accuracy confirmation unit (recognition accuracy confirmation unit 170) confirms the recognition accuracy of the relearned post-contraction multilayer neural network model (post-contraction DNN model 40). The recognition accuracy confirmation unit 170 is connected to the parameter setting unit 132 and the external recognition unit 310 of the autonomous driving ECU 300. The recognition accuracy confirmation unit 170 measures the recognition accuracy of the post-contraction DNN model 40, and confirms whether or not the recognition accuracy of the post-contraction DNN model 40 satisfies the target recognition accuracy. For example, the recognition accuracy confirmation unit 170 causes the post-contraction DNN model 40 to read several tens of images in which the object is known in advance, and obtains a ratio at which the post-contraction DNN model 40 can correctly recognize the object as the recognition accuracy. The confirmation result of the recognition accuracy of the post-contraction DNN model 40 by the recognition accuracy confirmation unit 170 is output to the parameter setting unit 132. Furthermore, in a case where the FPS confirmation unit 160 determines that the operation speed of the post-contraction DNN model 40 satisfies the target operation speed, and the recognition accuracy confirmation unit 170 determines that the recognition accuracy of the post-contraction DNN model 40 satisfies the target recognition accuracy, the recognition accuracy confirmation unit 170 outputs the post-contraction DNN model 40 to the external recognition unit 310 of the autonomous driving ECU 300.

Note that if the configuration of the post-contraction DNN model 40 becomes too simple, the operation speed of the post-contraction DNN model 40 becomes too fast, but the recognition accuracy may be deteriorated. Therefore, the DNN contraction device 100B confirms not only the operation speed of the post-contraction DNN model 40 but also the recognition accuracy, so that it can be confirmed whether the post-contraction DNN model 40 having a high operation speed and a high recognition accuracy is obtained.

Furthermore, the operation speed and the recognition accuracy of the post-contraction DNN model 40 may vary depending on the device to be executed. Therefore, in the FPS confirmation unit 160 and the recognition accuracy confirmation unit 170, the operation speed and the recognition accuracy are confirmed according to the type of the CPU of the autonomous driving ECU 300 in which the post-contraction DNN model 40 is executed. Therefore, the DNN contraction device 100B can generate the post-contraction DNN model 40 capable of realizing the optimum operation speed and recognition accuracy for each CPU of the autonomous driving ECU 300.

Then, the parameter setting unit (parameter setting unit 132) determines the contribution degree of the importance and the contribution degree of the number of arithmetic operations 50 of each layer based on the comparison result between the confirmed operation speed and the target operation speed and the comparison result between the confirmed recognition accuracy and the target recognition accuracy. As described above, the parameter setting unit 132 can set an optimal parameter for generating the post-contraction DNN model 40 based on the fed back comparison result of the operation speed and the comparison result of the recognition accuracy.

Note that, in FIG. 9, the process is performed in the order of the FPS confirmation unit 160 and the recognition accuracy confirmation unit 170, but the FPS confirmation unit 160 and the recognition accuracy confirmation unit 170 may be performed in parallel. In the case of parallel process, either the FPS confirmation unit 160 or the recognition accuracy confirmation unit 170 is configured to perform the determination in step S22 illustrated in FIG. 10 to be described later and output the post-contraction DNN model 40 to the external recognition unit 310.

Next, the operation of the DNN contraction device 100B will be described.

FIG. 10 is a flowchart illustrating an example of a process of the DNN contraction device 100B according to the third embodiment. Note that, in FIG. 10, the portions of the same processes as those in FIG. 8 are given the same reference numerals, and unless otherwise specified,
the portions are assumed to have the same or similar functions, and the description thereof will be omitted.

The processes up to steps S1, S11 to S13, and S2 to S4 are the same as the processes performed by the DNN contraction device 100A according to the second embodiment.

After contraction and relearning of the learned DNN model 10 are performed in step S4, the FPS confirmation unit 160 (an example of the operation speed confirmation unit) measures the operation speed (FPS) of the post-contraction DNN model 40 relearned by the DNN relearning unit 150. Furthermore, the recognition accuracy confirmation unit 170 measures the recognition accuracy from the DNN model relearned by the DNN relearning unit 150 (S21).

Next, the FPS confirmation unit 160 compares the measured operation speed with a target operation speed set in advance, and determines whether or not the measured operation speed has achieved the target operation speed (target FPS). Furthermore, the recognition accuracy confirmation unit 170 compares the measured recognition accuracy with the target recognition accuracy set in advance, and determines whether or not the measured recognition accuracy has achieved the target recognition accuracy (S22).

When the operation speed measured by the FPS confirmation unit 160 does not achieve the target operation speed (NO in S22), the FPS confirmation unit 160 feeds back the comparison result of the operation speeds to the parameter setting unit 132. The comparison result of the operation speed includes, for example, a numerical value of 70% with respect to the target operation speed. When the recognition accuracy measured by the recognition accuracy confirmation unit 170 has not achieved the target recognition accuracy (NO in S22), the recognition accuracy confirmation unit 170 feeds back the comparison result of the recognition accuracy to the parameter setting unit 132. The comparison result of the recognition accuracy includes a numerical value of 80% with respect to the target recognition accuracy.

Here, the recognition accuracy measured by the recognition accuracy confirmation unit 170 is calculated by how much the post-contraction DNN model 40 has been correct, for example, when an image of a sample, whose correct answer is known, is input to the post-contraction DNN model 40. For example, in a case where a correct answer is obtained for 80 sample images as a result of inputting 100 sample images to the post-contraction DNN model 40, the recognition accuracy confirmation unit 170 measures that the recognition accuracy of the post-contraction DNN model 40 is 80%. Note that the target accuracy is set with the recognition accuracy required by the user side. For example, if the target accuracy is 85%, the recognition accuracy of the post-contraction DNN model 40 is insufficient, and thus re-contraction of the learned DNN model 10 needs to be performed in the processes after the parameter setting unit 132 to re-learn the post-contraction DNN model 40. On the other hand, if the target accuracy is 75%, the recognition accuracy of the post-contraction DNN model 40 is sufficient, and thus re-contraction of the learned DNN model 10 and relearning of the post-contraction DNN model 40 become unnecessary.

In step S22, if at least one of the results of the operation speed measured by the FPS confirmation unit 160 has not achieved the target operation speed and the recognition accuracy measured by the recognition accuracy confirmation unit 170 has not achieved the target recognition accuracy is obtained (NO in S22), the comparison result is fed back to the parameter setting unit 132. The parameter setting unit 132 corrects the contribution degree parameters of the importance and the number of arithmetic operations based on the comparison results fed back from the FPS confirmation unit 160 and the recognition accuracy confirmation unit 170 (S23).

In step S23, when the operation speed has not achieved the target operation speed, the parameter setting unit 132 sets to increase the contribution degree parameter of the importance and decrease the contribution degree parameter of the number of arithmetic operations. In addition, in a case where the recognition accuracy has not achieved the target recognition accuracy, the parameter setting unit 132 sets to decrease the contribution degree parameter of the importance and increase the contribution degree parameter of the number of arithmetic operations. In addition, in a case where the operation speed has not achieved the target operation speed and the recognition accuracy has not achieved the target recognition accuracy, the parameter setting unit 132 sets to increase the contribution degree parameter of the importance and increase the contribution degree parameter of the number of arithmetic operations.

As an example, it is assumed that the operation speed and the recognition accuracy of a certain post-contraction DNN model 40 are measured. At this time, it is assumed that the measured operation speed=200 fps and the measured recognition accuracy=60 pt (%). In addition, it is assumed that the target operation speed=220 fps and the target recognition accuracy=50 pt (%). At this time, the FPS confirmation unit 160 compares the measured operation speed with the target operation speed, and determines that the measured operation speed has not achieved the target operation speed. In addition, the recognition accuracy confirmation unit 170 compares the measured recognition accuracy with the target recognition accuracy, and determines that the measured recognition accuracy satisfies the target recognition accuracy. Therefore, since the operation speed has not achieved the target, the parameter setting unit 132 corrects the parameter for increasing the contribution degree parameter of the importance from 0.5 to 0.6 and decreasing the contribution degree parameter of the number of arithmetic operations from 0.5 to 0.4. Note that there is no limitation that the contribution degree of the importance and the contribution degree of the number of arithmetic operations add up to 1.0.

Thereafter, each layer contraction rate calculation unit 131 again calculates the contraction rate of each layer of the DNN model, and the DNN contraction unit 140 contracts the DNN model based on the calculated contraction rate of each layer. Furthermore, the DNN relearning unit 150 relearns the DNN model. Then, the measurement of the operation speed and the recognition accuracy in steps S21 and S22, and the comparison between the measured operation speed and the recognition accuracy and the target operation speed and the target recognition accuracy are performed again.

In step S23, if the measured operation speed has achieved the target operation speed and the measured recognition accuracy has achieved the target recognition accuracy (YES in S23), the DNN relearning unit 150 outputs the relearned post-contraction DNN model 40 to the autonomous driving ECU 300 of the vehicle 500 (S5). After the process of step S5, the process of the DNN contraction device 100B ends.

In the autonomous driving system 1B according to the third embodiment described above, when the measured operation speed satisfies the target operation speed and the measured recognition accuracy satisfies the target recognition accuracy, the post-contraction DNN model 40 is output to the autonomous driving ECU 300. Therefore, the autonomous driving ECU 300 can recognize the outside world with sufficient operation speed and recognition accuracy using the post-contraction DNN model 40, and does not cause waste of process.

### Fourth Embodiment

In the DNN contraction device according to the first to third embodiments, the contraction of the learned DNN model 10 in consideration of the situation in which the vehicle 500 is placed, the situation around the vehicle 500, and the like is not performed. However, it has been desired to generate the post-contraction DNN model 40 suitable for the situation of the vehicle 500. Therefore, the DNN contraction device according to the fourth embodiment generates a post-contraction DNN model 40 suitable for the situation of the vehicle 500.

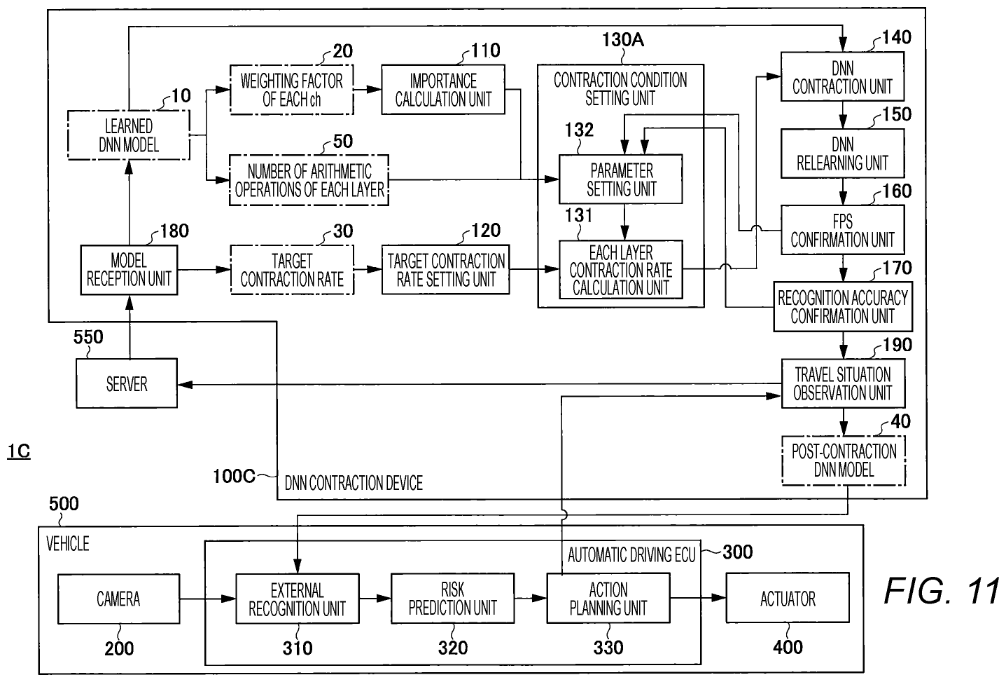

Therefore, a configuration example and an operation example of an autonomous driving system according to a fourth embodiment of the present invention will be described with reference to FIG. 11.

FIG. 11 is a block diagram illustrating a configuration example of an autonomous driving system 1B including a DNN contraction device 100C according to the fourth embodiment. In FIG. 11, the same names and numbers are given to blocks that perform the same process as in FIG. 9, and unless otherwise specified, the blocks are assumed to have the same or similar functions, and the description thereof will be omitted.

An autonomous driving system 1C according to the fourth embodiment includes a DNN contraction device 100C, an autonomous driving ECU 300 of a vehicle 500, and a server 550.

For example, when the weather is sunny, the image photographed by the camera 200 shows an object at a far distance from the front side of the vehicle 500, and the external recognition unit 310 can recognize this object. However, when the weather is rainy, it is difficult to distinguish even an object, at a short distance from the front side of the vehicle 500, from the background in the image photographed by the camera 200, and the external recognition unit 310 may not recognize this object.

Therefore, when contracting the learned DNN model 10, the DNN contraction device 100C obtains information on the situation of the vehicle 500 (during traveling, during stopping, etc.) or the situation around the vehicle 500 (traffic congestion, bad weather, etc.), and can replace the pre-contraction learned DNN model 10. The DNN contraction device 100C has a configuration in which a model reception unit 180 and a travel situation observation unit 190 are newly added to the DNN contraction device 100B according to the third embodiment.

The travel situation observation unit (travel situation observation unit 190) observes the travel situation of the vehicle in which the post-contraction multilayer neural network model (post-contraction DNN model 40) is used, and outputs the observation result of the travel situation to a server (server 550) that saves a plurality of multilayer neural network models (learned DNN models 10). The travel situation observation unit 190 is connected to the server 550, and the external recognition unit 310 and the action planning unit 330 of the autonomous driving ECU 300. The travel situation observation unit 190 receives the action plan of the vehicle 500 from the action planning unit 330 of autonomous driving ECU 300. Then, the travel situation observation unit 190 observes the travel situation of the vehicle 500 based on the received action plan. In addition, the travel situation observation unit 190 transmits a travel situation observation result indicating the observed travel situation of the vehicle 500 to the server 550.

Furthermore, when receiving the post-contraction DNN model 40 relearned by the DNN relearning unit 150 via the FPS confirmation unit 160 and the recognition accuracy confirmation unit 170, the travel situation observation unit 190 outputs the post-contraction DNN model to the external recognition unit 310. When the post-contraction DNN model 40 reflecting the travel situation of the vehicle 500 is created, the travel situation observation unit 190 can also output the post-contraction DNN model 40 reflecting the travel situation of the vehicle 500 to the external recognition unit 310.

The server 550 is, for example, a cloud server, and can transmit and receive various data to and from the DNN contraction device 100C by wireless or wired communication. The server 550 saves a plurality of DNN models in a storage device (not illustrated). The DNN model saved in the server 550 is prepared in advance in accordance with a representative travel situation of the vehicle 500.

Then, when receiving the travel situation observation result from the travel situation observation unit 190 included in the DNN contraction device 100C, the server 550 selects the DNN model to be transmitted to the model reception unit 180 based on the received travel situation observation result. Thereafter, the server 550 transmits the selected model to the model reception unit 180.

As the DNN model selected by the server 550 and transmitted to the model reception unit 180, a DNN model learned in advance by a learning device (not illustrated) is used. Then, the server 550 selects a DNN model learned for each travel situation of the vehicle 500 based on the travel situation observation result received from the travel situation observation unit 190. For example, the range of the outside world to be recognized by the external recognition unit 310 may be different between when the vehicle 500 is traveling and when the vehicle is stopped. Therefore, the server 550 selects a DNN model for stopping when the vehicle 500 is stopped, selects a DNN model for traveling when the vehicle 500 is traveling, and transmits the selected DNN model to the model reception unit 180.

The model reception unit (model reception unit 180) receives the multilayer neural network model (learned DNN model 10) suitable for the travel situation selected from the server (server 550) based on the observation result of the travel situation. Then, the model reception unit (model reception unit 180) sets the multilayer neural network model (learned DNN model 10) received from the server (server 550) as the multilayer neural network model (learned DNN model 10) read by the importance calculation unit (importance calculation unit 110). Therefore, the post-contraction DNN model 40 is created using the learned DNN model 10 corresponding to the travel situation of the vehicle 500.

In the autonomous driving system 1C according to the fourth embodiment described above, the DNN model according to the travel situation of the vehicle 500 is selected by the server 550 and is taken into the DNN contraction device 100C as the learned DNN model 10. Then, the DNN contraction device 100C performs a predetermined process on the learned DNN model 10 that has been taken in to create the post-reduction DNN model 40, and outputs the post-reduction DNN model 40 to the autonomous driving ECU 300. Therefore, the autonomous driving ECU 300 can accurately control the vehicle 500 using the post-contraction DNN model 40 created in accordance with the travel situation of the vehicle 500.

In addition, the post-contraction DNN model 40 generated by the DNN model selected according to the travel situation of the vehicle 500 is used in the autonomous driving ECU 300. For example, while the post-contraction DNN model 40 used when the vehicle 500 is traveling has a large number of arithmetic operations, the post-contraction DNN model 40 used when the vehicle 500 is stopped has a small number of arithmetic operations, so that the power consumption of the autonomous driving ECU 300 can be reduced.

Furthermore, the travel situation observation unit 190 may obtain the current position of vehicle 500 by receiving global positioning system (GPS) information received by vehicle 500 together with the action plan from the action planning unit 330 of the autonomous driving ECU 300. If the current position of the vehicle 500 is known, the travel situation observation unit 190 can receive weather information or the like corresponding to the current position, and thus may transmit the weather information to the server 550 together with the travel situation observation result. In this case, the server 550 can select the DNN model according to the weather information.

As a modification of the autonomous driving system 1C according to the fourth embodiment, the model reception unit 180 may hold a plurality of DNN models in advance, and the model reception unit 180 may receive the travel situation observation result from the travel situation observation unit 190. In such a configuration, the model reception unit 180 may select the DNN model to be used as the learned DNN model 10 in the DNN contraction device 100C based on the travel situation observation result.

In addition, the travel situation observation unit 190 observes a travel situation of the vehicle 500 (traveling or stopping) and a surrounding situation of the vehicle 500 (presence or absence of congestion, weather, and the like). Therefore, if the model reception unit 180 is configured to select the DNN model, the travel situation observation unit 190 may feed back the travel situation directly to the model reception unit 180 by the travel situation observation unit 190 without passing through the server 550. For example, the travel situation observation unit 190 can also observe the actual travel situation of the vehicle 500 based on information obtained from the actuator 400, the sensor, the autonomous driving ECU 300, and the like.

In addition, since the travel situation observation unit 190 observes the travel situation of the vehicle 500, when the vehicle 500 fails, the information detected by each sensor of the vehicle 500 may be received from the autonomous driving ECU 300 as the travel situation observation result. In this case, a DNN model corresponding to the failure mode of the vehicle 500 is selected, and the DNN contraction device 100C generates the post-contraction DNN model 40 from the selected DNN model. Therefore, the autonomous driving ECU 300 can perform autonomous driving process using the post-contraction DNN model 40 generated in accordance with the failure mode.

In addition, the server 500 can determine the quality of the DNN model selected before the failure of the vehicle 500 later, and determine by itself whether the DNN model has been appropriately selected in what kind of travel situation, or leave the determination to the user. Then, the server 500 can select a DNN model in which a failure of the vehicle 500 is unlikely to occur and transmit the DNN model to the model reception unit 180.

Furthermore, the DNN contraction device 100C may be in a form of being mounted on the vehicle 500. In this case, the travel situation of the vehicle 500 is observed by the travel situation observation unit 170 in real time. As a result, the DNN model according to the current travel situation of the vehicle 500 is selected by the server 550, and the DNN contraction device 100C can generate the post-contraction DNN model 40 from the DNN model in real time. Therefore, the external recognition unit 310 receives the post-contraction DNN model 40 according to the current travel situation of the vehicle 500 in real time, and the external recognition unit 310 can accurately recognize the object. As described above, if the model reception unit 180 is configured to select the DNN model, in the travel situation observation unit 190, the travel situation observation unit 190 may directly feed back the travel situation to the model reception unit 180 without passing through the server 550, and the model reception unit 180 may select the DNN model.

Note that the DNN contraction device according to each of the above-described embodiments has been described as an example of an arithmetic device that contracts a DNN. However, the arithmetic device according to the present invention may be applied to a device that contracts a multilayer neural network other than a DNN.

In addition, the present invention is not limited to each embodiment described above, and it goes without saying that various other application examples and modifications can be taken without departing from the gist of the present invention described in the claims.

For example, each of the above-described embodiments has specifically described in detail the configuration of the device and the system in order to describe the present invention in an easy-to-understand manner, and is not necessarily limited to those having all the described configurations. In addition, a part of the configuration of the embodiment described here can be replaced with the configuration of another embodiment, and furthermore, the configuration of another embodiment can be added to the configuration of an embodiment. In addition, it is also possible to add, delete, and replace other configurations for a part of the configuration of each embodiment.

In addition, the control lines and the information lines indicate what is considered to be necessary for the description, and do not necessarily indicate all the control lines and the information lines on the product. In practice, it may be considered that almost all the configurations are connected to each other.

### REFERENCE SIGNS LIST

1 autonomous driving system
10 learned DNN model
20 weighting factor of each ch
30 target contraction rate
40 post-contraction DNN model
50 number of arithmetic operations of each layer
100 DNN contraction device
110 importance calculation unit
120 target contraction rate setting unit
130 contraction condition setting unit
131 layer contraction rate calculation unit
132 parameter setting unit
140 DNN contraction unit
150 DNN relearning unit
160 FPS confirmation unit
170 recognition accuracy confirmation unit
180 model reception unit
190 travel situation observation unit
300 autonomous driving ECU
310 external recognition unit
320 risk prediction unit
330 action planning unit
500 vehicle

1. An arithmetic device comprising:
an importance calculation unit that calculates an importance of a channel by using a weighting factor set for the channel of a multilayer neural network model having the channel including a plurality of neurons for each of an input layer, an intermediate layer, and an output layer;
a target contraction rate setting unit that sets a target contraction rate for the entire multilayer neural network model;
each layer contraction rate calculation unit that calculates a contraction rate of each layer of the multilayer neural network model based on the importance and the target contraction rate;
a contraction unit that contracts each layer in accordance with the contraction rate calculated by each layer contraction rate calculation unit to generate a post-contraction multilayer neural network model; and
a relearning unit that performs relearning of the post-contraction multilayer neural network model.

2. The arithmetic device according to claim 1, wherein the importance calculation unit calculates an importance of the channel at a preceding stage connected to the channel at a subsequent stage based on the importance of the channel at the subsequent stage and a weighting factor of the channel at the subsequent stage in order from a layer closer to the output layer, and
the each layer contraction rate calculation unit calculates a target contraction rate of each layer with respect to the target contraction rate of the entire multilayer neural network model based on the importance in each layer of the importance calculated for each channel.

3. The arithmetic device according to claim 2, further comprising,
a parameter setting unit that sets the importance and number of arithmetic operations of each layer extracted from the multilayer neural network model as parameters, wherein
the each layer contraction rate calculation unit calculates a target contraction rate of each layer based on the parameter and the target contraction rate in the entire multilayer neural network model.

4. The arithmetic device according to claim 3, wherein the parameter setting unit sets a contribution degree of the importance calculated for each of the channels and a contribution degree of the number of arithmetic operations of each of the layers as the parameter.

5. The arithmetic device according to claim 4, further comprising,
an operation speed confirmation unit that confirms an operation speed from the relearned post-contraction multilayer neural network model; and
a recognition accuracy confirmation unit that confirms recognition accuracy of the relearned post-contraction multilayer neural network model; wherein
the parameter setting unit determines the contribution degree of the importance and the contribution degree of the number of arithmetic operations of each layer based on a comparison result between the confirmed operation speed and a target operation speed and a comparison result between the confirmed recognition accuracy and target recognition accuracy.

6. The arithmetic device according to claim 5, further comprising:
a travel situation observation unit that observes a travel situation of a vehicle using the post-contraction multilayer neural network model and outputs an observation result of the travel situation to a server that stores a plurality of multilayer neural network models; and
a model reception unit that receives the multilayer neural network model suitable for the travel situation selected from the server based on the observation result of the travel situation, and sets the multilayer neural network model received from the server as the multilayer neural network model to be read by the importance calculation unit.

7. The arithmetic device according to claim 2, wherein the multilayer neural network model is a deep neural network model.

8. An arithmetic method comprising:
calculating an importance of a channel by using a weighting factor set for the channel of a multilayer neural network model having the channel including a plurality of neurons for each of an input layer, an intermediate layer, and an output layer;
setting a target contraction rate for the entire multilayer neural network model;
calculating a contraction rate of each layer of the multilayer neural network model based on the importance and the target contraction rate;
contracting each layer to achieve the contraction rate; and
relearning with the post-contraction multilayer neural network model.
